(19) United States
(12) Patent Application Publication
(10) Pub. No.: US 2006/0079995 A1
(43) Pub. Date: Apr. 13, 2006

(54) Dispenser distribution box for fuel dispenser application

(75) Inventors: Walter E. Warn, Knightdale, NC (US); Fred K. Carr, Chapel Hill, NC (US)

Correspondence Address: Fred K. Carr, 2422 Atlantic Ave, Raleigh, NC, 27604, US

(73) Assignee: Progressive International Electronics, Inc., Raleigh, NC (US)

(21) Appl. No.: 11/047,045

(22) Filed: Feb. 1, 2005

Related U.S. Application Data
(62) Division of application No. 10/959,954, filed on Oct. 7, 2004.

(51) Int. Cl. G06F 17/00

(52) U.S. Cl. 700/239

(57) ABSTRACT

The present invention relates to a fuel dispenser control system used in combination with a host computer for controlling the fuel dispensing process, and with newer dispensers, for accepting payment by credit card or cash dispenser. The fuel control system includes a fuel controller application installed on the operating system of the computer, and includes a host application interface, a fuel dispenser control section, and a fuel dispenser brand specific section. The system includes an OLE-II server, residing in the host computer, for receiving and processing commands from the host application section. The host application interface interfaces the fuel controller application to the host computer, the fuel dispenser control section controls the dispensers, and the dispenser brand specific section formats the communication signals according to the type dispenser being controlled. The fuel controller application communicates with the fuel dispensers through a dispenser distribution box by either standard serial communication or Ethernet circuitry for controlling the dispensers and receiving responses from the dispensers.

### RELATED PATENTS

This application is a divisional application of U.S. application Ser. No. 10/959,954, filing date Oct. 7, 2004, Walter E. Warn and Fred K. Carr inventors.

### FIELD OF THE INVENTION

The present invention relates to a device and method for controlling fuel dispensers, and more particularly, to a fuel dispenser controller application installed on a host computer at the fueling site such that the host computer can control the fuel dispensers as well as simultaneously perform other tasks at the fueling site.

### BACKGROUND OF THE INVENTION

Several commercial brands of fuel dispensers are used in the retail petroleum industry to dispense fuel to the traveling public including Gilbarco, Tokheim, Wayne Dresser, and others. These dispensers generally include a microprocessor (MP), read-only-memory (ROM), and read-and-write-memory (RAM), for reading, writing, and storing information on the dispensing process. The dispensers are often controlled by a remote dispenser controller located in a building at the site such that an attendant can monitor and control the dispensing process. The controller sends data signals (commands) to the dispensers and the dispensers send data signals (responses) to the controller. Dispenser manufacturers have a proprietary protocol for communicating between the dispensers and the dispenser controller. Certain dispenser manufacturers use current loop communication, others use voltage level communication, and others a combination thereof. Most newer dispenser models include a card reader means for reading credit and debit cards as well as a cash receptor for taking cash for the fuel dispensed.

One type of dispenser controller, which has gained wide spread popularly during recent years, is the personal computer (PC). The PC is particularly well suited for this since it can simultaneously perform other functions including cash register, scanning, wet and dry stock inventory, accounting, payroll, as well as other modules. The present invention relates to a fuel controller application, which is installed on the operating system of the host PC, for controlling the dispensers while the PC simultaneously performs other task. These systems are generally referred to Point-of-Sales (POS) systems in the industry.

U.S. Pat. No. 5,299,135 issued to Lieto ET. Al relates to an interface unit, with bus connection to a PC, for regulating the exchange of information between a dispenser and PC. The present disclosure improves on the Lieto patent by putting the fuel dispenser control and the fuel dispenser brand information in server software residing in the host PC software such that the dispenser control software registers with the host PC operating system.

U.S. Pat. Nos. 5,270,943, 5,557,529, 5,694,326 and 5,790,410 issued to Warn ET. AL relate to a dispenser controller hardware device positioned in the communication line between the controlling PC and the dispensers. U.S. Patent 943 discloses a pump control board (PCC) with parallel connection to the PC main board; Patents 529, 326, and 410 disclose an external controller (PCXZ) with serial connection to the PC. Both the PCC and the PCXZ are used in combination with a configurator for adjusting the signal to the type dispenser being controlled. The PCC and the PCXZ are external systems to the PC, and have a MP, ROM, and RAM for storing and processing the fuel dispenser control programs and the fuel dispenser specific information. The present disclosure eliminates the need for the external PCC and PCXZ boards; it puts the dispenser control and dispenser brand information in the server software registering with the host operating system. This eliminates the need for the extra hardware, and more importantly, possible points of failure in the overall control system during field operation.

### SUMMARY OF THE INVENTION

In summary, the present invention provides a fuel dispenser control system used in combination with a host computer for controlling the fuel dispensing process, and with newer dispensers, for accepting payment for the fuel dispensed through a credit card reader or a cash acceptor. The control system includes a fuel controller application installed on the operating system of the host computer. The fuel controller application is made up of three sections including: the host application interface, the fuel dispenser control section, and the fuel dispenser brand specific section. The system includes an OLE-II server, residing in the host computer, which receives and processes commands from the host application section. The host application interface interfaces the fuel controller application to the host computer; the fuel dispenser control section controls the dispensers; and the dispenser brand specific formats the signals according to the type dispenser being controlled. The fuel controller application communicates with the fuel dispensers through a dispenser distribution box by either standard serial or Ethernet circuitry for controlling the dispensers and receiving responses from the dispensers.

Accordingly, the primary object of this invention is to provide a fuel dispenser control system for controlling fuel dispensers through a host computer.

A further object of this invention is to provide a dispenser control system having a fuel controller application installed on the operating system of the computer.

A further object of this invention is to provide a dispenser control system having a fuel controller application installed on the operating system of the computer such that the computer can simultaneously perform other task.

A further object of this invention is to provide a dispenser control center which can control different brands of dispensers.

A further object of this invention is to provide a dispenser control system which can control different brands of dispensers with credit card readers.

A further object of this invention is to provide a dispenser control system which can control different dispenser brands with cash acceptors.

### BRIEF DESCRIPTION OF THE DRAWINGS

Other objects of this invention will appear in the following specifications and claims, reference being made to the accompanying drawings which form a part thereof.

FIG 1 is a schematic diagram of a fuel dispensing facility with dispensers functionally connected to a host computer for controlling the dispensers.

FIG 2 is a block diagram of a dispenser distribution box for adjusting the signals of different dispenser brands.

FIG 3 is a flow chart illustrating the programming for configuring the serial port of the dispenser distribution box used to communicate with the dispensers.

FIG 4 is a flow chart illustrating the programming for setting the control signal of the dispenser distribution box.

FIG 5 is a flow chart illustrating the programming for sending data between the dispensers and the host computer.

### DETAILED DESCRIPTION OF THE INVENTION

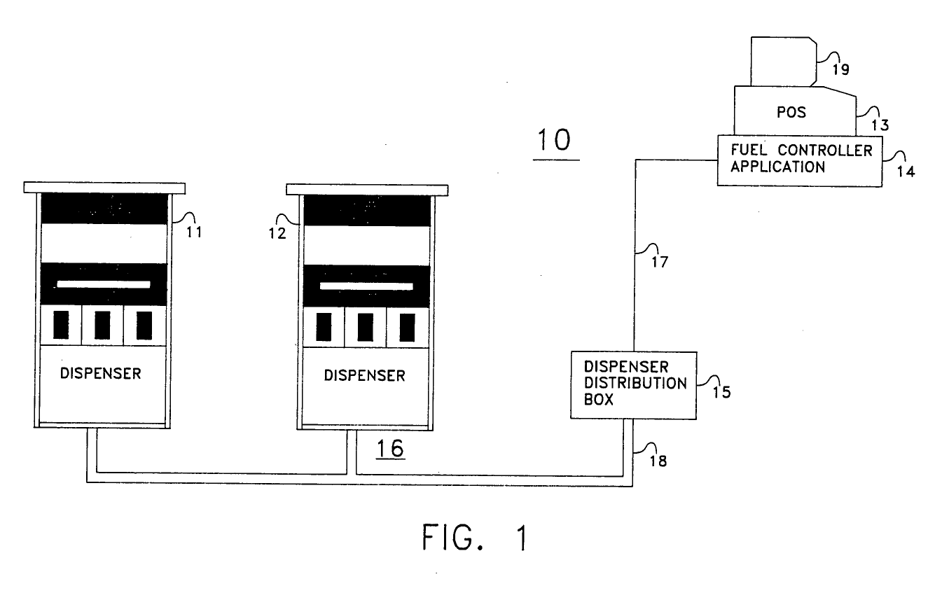

Referring now to the drawings, and first to FIG. 1, there is shown a schematic overview of a fuel dispensing system, generally designated (10). There is shown two dispensers (11,12) electrically connected to a PC (13) through a communication system, generally designated (16). The communication system (16) includes wire (17) from the PC (13) to the dispenser distribution box (15) and the wire (18) from the dispenser distribution box (15) to the dispensers (11,12) which forms a loop in the illustration. The host PC (13) controls the fueling process at the dispensers (11,12) by transferring data signals to and from the dispensers through communication system (16). The dispenser distribution box (I5), located between the PC (13) and the dispensers (11,12), includes translation circuits for adjusting the signal types between the PC (13) and the dispensers (11,12). This causes the signals to be compatible with the dispenser brand and model being controlled. A fuel controller application (14) program is interfaced to the operating system of PC (13) for controlling the dispensers and formatting the signals to the dispensers according to the brand and model dispenser being controlled.

PC-based POS systems are widely used in the retail petroleum industry since this type system allows integration of features as pump control, cash register function, card authorization, inventory control, and related. Generally, these tasks are performed by auxiliary software programs interfaced to the main POS application program. The present invention allows one to control the dispensers (11,12) by a fuel controller application (14) interfaced to the PC (13) operating system. In this specification, PC is generally defined as a self-contained computing unit used in stand alone mode or in a network of computing units, constituting a host computer means. The PC (13) is connected to a monitor (19).

An important feature of the present invention is the fuel controller application (14). An OLE-II server links the fuel controller application (14) to the host PC (13) operating system. The fuel controller application (14) is made up of three sections: the host application interface section, the fuel dispenser control section, and the fuel dispenser brand specific section. The host application interface section provides an interface between the host PC (13) application and the fuel dispenser control section. The dispenser control section sends commands to the dispensers (11,12) and receives responses from the dispensers (11,12) to control and monitor the fueling process. The fuel dispenser brand specific section provides software routines to control different dispenser brands. The above constitutes a fuel controller application means. As previously discussed in the BACKGROUND section, U.S. PATENTS 943, 529, 326 and 410 disclose controllers whereby the dispenser control functions and dispenser brand specific functions reside in boards either parallel or serially connected to the host operating system through an OLE-II server. In the present disclosure, these sections are included in the OLE-II server software.

When the fuel controller application (14) is installed on the host PC (13) during operation, the fuel controller registers its program interfaces with the host operating system establishing a software link between the host application and the fuel controller functions. When the host computer application is launched, a link to the fuel controller is requested and the fuel controller application is launched. The link to the fuel controller is designed such that multiple host applications can connect simultaneously as over a network allowing host applications from other computers to link to the fuel controller. When all host applications requiring a link to the fuel controller application are closed, the fuel controller application is closed.

The host application interface waits for commands from the host application. When a command is received, the host interface section processes the command and there after either stores the information for the fuel control section to process, or sends response data requested back to the host computer, or both.

The fuel dispenser control section is constantly looping the communication circuit, processing commands from the host interface section, and performing house keeping operations on the fuel dispensers such as requesting current status, requesting current sale information if a fuel dispenser has fuel flowing, receiving credit card data when read and receiving key input data when ready. The fuel dispenser control section keeps all information current and ready for the host interface section. The fuel dispenser control section provides a systematic sequence of operations to ensure all fuel dispensers are serviced in a timely fashion and all fuel dispenser commands are processed as needed.

Each fuel dispenser brand has a unique protocol and command structure. The fuel dispenser brand specific section provides all the software routines necessary to control the specific brand of fuel dispenser. The link between the fuel dispenser control section has a standard data format structure for passing information. The fuel dispenser brand specific section interprets the command information and controls the dispensers while formatting all return information into the format requested by the fuel dispenser control section.

Referring now back is FIG. 1, there is shown the dispenser distribution box (15). The dispenser distribution box (15) provides a wire connection between the fuel controller application and the dispensers (11,12). The dispenser distribution box allows the communication signals (commands) from the fuel controller application to flow to the dispensers (11,12), and the signals (responses) to flow from the dispensers (11,12) to the fuel controller application (14).

The communication system, generally designated (16), includes connection (17) from the dispenser distribution box (15) to the fuel controller application (14) and a connection (18) from the dispenser distribution box (15) to the dispensers (11,12). The fuel dispenser application (14) has both a standard serial port and Ethernet circuit port, therefore, either standard serial RS232 or Ethernet communication can be used from the fuel dispenser application (14) to the dispensers (11.12). The above constitutes a communication means. Wire connection (18) shown in FIG. 1 is an example of current loop as used by Gilbarco, other dispensers manufacturers use voltage level, or newer dispensers use an Ethernet connections. It is the dispenser distribution box (15) and the dispenser brand specific section of the fuel dispenser application (14) which allows the system to control different dispenser brands.

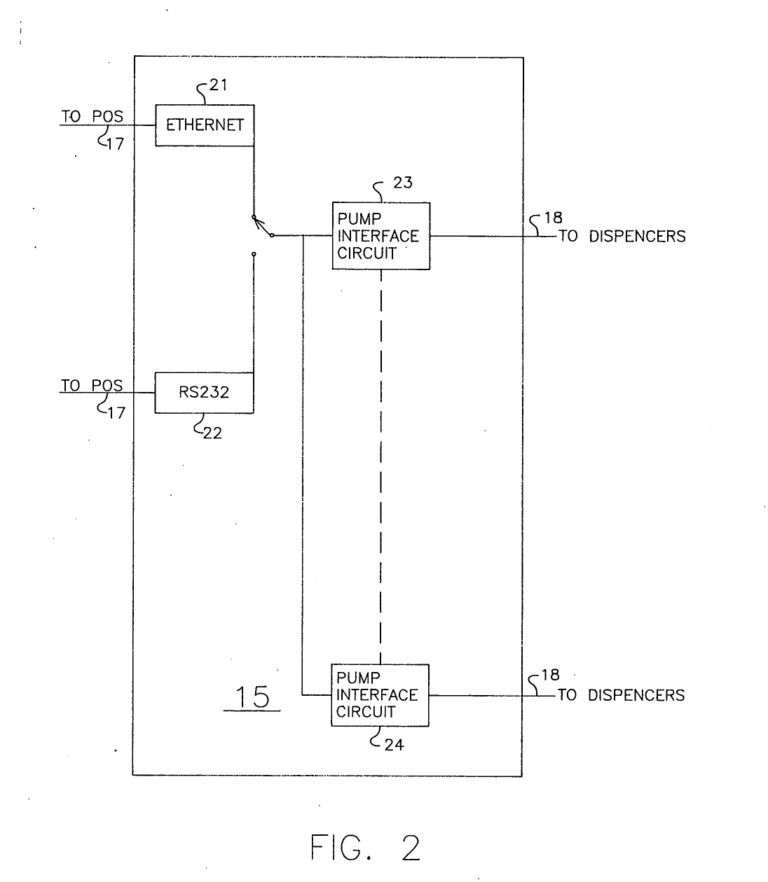

Referring now to FIG. 2, there is shown a block diagram of the dispenser distribution box, generally designated (15). The dispenser distribution box (15) provides a method for connecting the fuel controller application (14) to the dispensers (11,12). The dispenser distribution box (15) allows the communication signals from the fuel controller application (14) to flow to and from the dispensers (11,12). The dispenser distribution box (15) has Ethernet circuitry (21) and a standard serial port circuitry (22) for connecting the fuel control application (14) to the dispenser distribution box (15). Either the Ethernet (14) or the serial port (15) can be utilized in field operation. This would depend on the model of the dispensers being controlled. Referring back to FIG. I, it can be seen that wire connection (17) connects the POS (13) and the fuel controller application (14) to the dispenser distribution box (15).

Referring further to FIG. 2, there is shown a method for connecting the Ethernet (21) or the serial port (22) to the dispensers (11,12). Serial data received from fuel dispenser application (14), either from the standard serial port or the TCP/IP Ethernet connection, is sent through translation circuits (23,24) for adjusting the signal type to be compatible with the individual fuel dispenser brand (11,12) and model being controlled. Likewise, serial data received from the fuel dispensers (11,12) is sent through the translation circuits (23,24) for adjusting the signal to be compatible with either the standard serial port or the TCP/IP Ethernet connection to the fuel controller application (14). Wire connection (18), as seen in FIG. I, connects the dispenser distribution box (15) to the dispensers (11,12). The example shows two dispensers, but this may vary from one dispenser at a small site to many as one may find at a truck stop.

As previously mentioned and more fully discussed in U.S. PATS No. 942, 529, 326, and 410, different dispenser manufacturers use different forms of communication and a proprietary protocol to communicate between the dispenser controller and the dispenser. For example, Gilbarco uses current level communication. In this case, the translation circuits (21,22) include opto-couplers with light emitting diode and transistor for translating current levels between the two. As another example, Tokheim uses voltage levels. The translation circuits (21,22) in these systems include a comparator for translating voltage levels in the communication between the dispenser distribution box (15) and the dispensers (11,12).

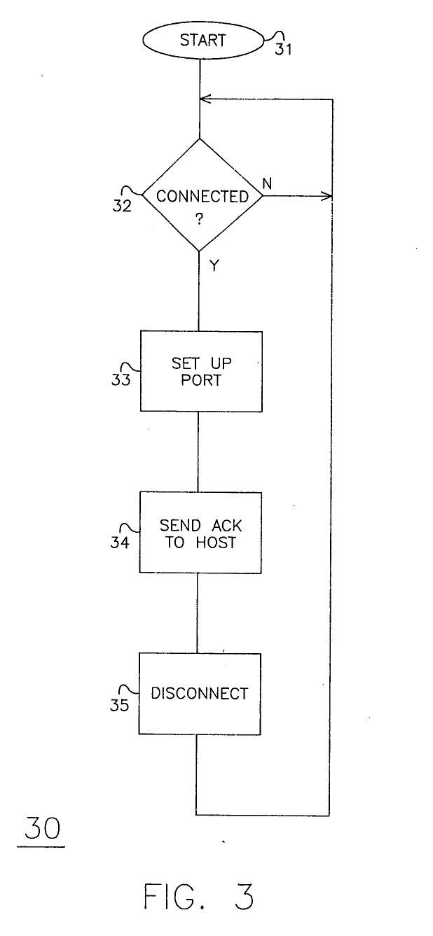

On power up, the TCP/IP Ethernet connection initializes and waits for TCP/IP connection from the fuel controller application. There are three Ethernet connections in the preferred embodiment available to the fuel controller application: connection 1—port setup, connection 2—control signal, and connection 3—protocol data. Referring now to FIG. 3, there is shown a flow chart generally designated (30), demonstrating connection 1—port setup. Start block (31), is connected to decision block (32) to determine if there is connection. A NO response loops back to start. When a YES response is detected showing connection has been established, data is sent by the fuel controller application to configure the serial port to communicate with the dispensers (11,12). An ACK signal is sent back to the fuel controller application as show in send ACK block (34) indicating operation is complete, followed by the disconnect block (35).

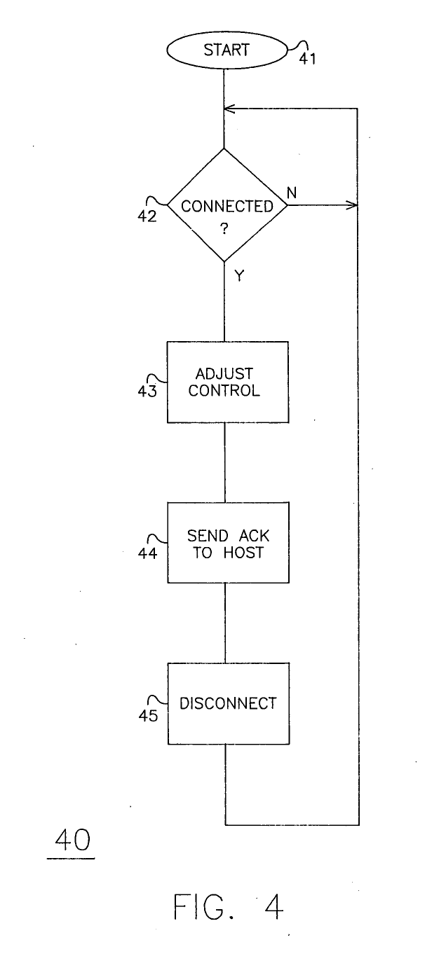

Referring now to FIG. 4, there is shown a flow chart for connection 2—control signal, generally designated (40). Decision box (42) determines if there is connection. When connection is established, data is sent by the fuel controller application (14) to set or reset the control signal of the dispenser distribution box (15) shown by the adjust control block (43). An ACK signal is sent back to the fuel controller application as shown by send ACK to host block (44) indicating the operation is complete, followed by the disconnect block (45) looping black to start (41).

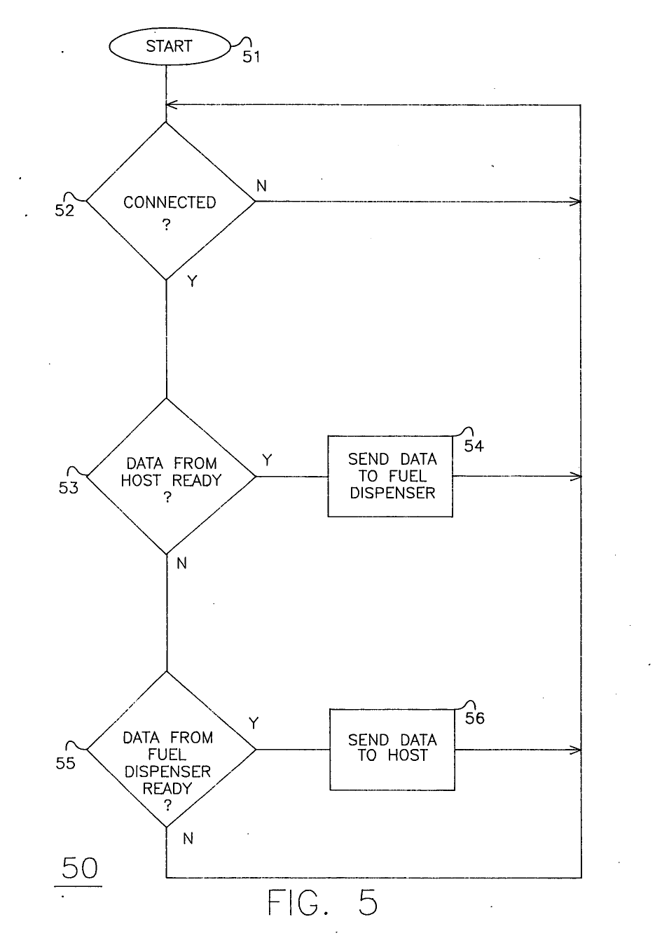

Referring now to FIG. 5, there is shown a flow chart for connection 3—protocol data, generally designated (50). When connection has been established through decision block (52), data is sent from the fuel controller application (14) through decision data from controller ready block (53) and data to dispenser blocked (54); data sent from the dispensers (11,12) is sent to the fuel controller application (14) through the data from dispenser ready block (55) and send data to host block (56).

The present invention may, of coarse, be carried out in ways other than those herein set forth without parting from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A dispenser distribution system including a distribution box electrically connected between a host computer having a fuel controller application and at least one fuel dispenser, comprising:
(a) first communication means, functionally connected between said controller application and said distribution box, for transmitting communication signals to and from said application and said distribution box; and
(b) second communication means, functionally connected between said distribution box and said fuel dispenser, for transmitting said communication signals between said distribution box and said dispenser.

2. A distribution system as defined in claim 1 wherein said first communication means includes Ethernet circuitry for transmitting said communication signals.

3. A distribution system as defined in claim 1 wherein said first communication means includes standard serial communication ports for transmitting said communication signals.

4. A distribution system as defined in claim 3 wherein said serial port includes a RS-232 connection.

5. A distribution system as defined in claim 1 wherein said second communication means includes an interface circuit means for adjusting said communication signal to be compatible with the dispenser brand and model being controlled.

6. A distribution system as defined in claim 5 wherein said interface circuit means includes an opto-coupler with light emitting diode and transistor for adjusting circuit levels to communicate with said dispenser.

7. A distribution system as defined in claim 5 wherein said interface circuit means includes a comparator for adjusting voltage levels to communicate with said dispenser.

8. A method for controlling the fuel dispensing process by a fuel dispenser control system used in combination with at least one fuel dispenser having a pump means and a host computer including a fuel controller application means interfaced to the operating system of said computer for controlling said fuel dispensers and for formatting command and response data between said dispensers and said host computer and a dispenser distribution means functionally connecting said dispensers and said fuel controller application means for translating and adjusting command and response data between dispensers and said fuel controller application means, comprising the steps of:
(a) initializing on power up a TCP/IP Ethernet connection from said fuel controller application;
(b) sending data from said fuel controller application to configure the serial port used to communicate with said fuel dispensers, followed by an ACK signal back to said fuel controller application indicating the operation is complete;
(c) sending data from said fuel controller application to set or reset the control signal of said dispenser distribution box, followed by an ACK signal to said fuel controller application to indicate the operation is complete; and
(d) sending data from said fuel controller application to said dispensers and sending data from said dispensers back to said fuel controller application.
